(19) United States
(12) Patent Application Publication
(10) Pub. No.: US 2016/0308357 A1
(43) Pub. Date: Oct. 20, 2016

(54) DIFFERENTIATED CONTROL METHOD OF THE CASCADED ACTIVE POWER FILTER

(71) Applicant: Junling Chen, Beijing (CN)

(72) Inventor: Xuefei Yuan, Beijing (CN)

(21) Appl. No.: 15/100,980

(22) PCT Filed: May 6, 2014
(86) PCT No.: PCT/CN2014/000466

§ 371 Date: Jun. 1, 2016

(30) Foreign Application Priority Data
Feb. 12, 2014 (CN) 201410048458.4

(51) Int. Cl. H02J 3/18; H02M 1/12; H02M 7/219; H02M 1/42

(52) U.S. Cl. CPC H02J 3/1857; H02M 1/4233; H02M 1/12; H02M 7/219

(57) ABSTRACT

The present invention relates to a differentiated control method of the cascaded active power filter, wherein the cascaded links are divided into low frequency links and high frequency links; wherein low frequency links are used to generate the fundamental voltage generated by the cascaded multilevel converter; wherein high frequency links are used to produce different, separate voltage from the aforementioned fundamental voltage generated by the cascaded multilevel converter; wherein according to the given cycle, some links are selected circularly from cascaded links as the high frequency links; wherein in the control cycle, each phase links with the maximum and minimum DC capacitor voltage, as well as those links that the pulse width modulation (PWM) combination discharge and charge most to DC capacitor are found out.

### TECHNICAL FIELD

The present invention relates to the fields of reactive power compensation and harmonic suppression in the power system, and involves a differentiated control method of the cascaded active power filter.

### BACKGROUND

With the development of electronic power technology, many non-linear electronic power devices are widely applied to power systems. The significant increase of apparatus capacity and the diversity of control methods generate high grid voltage harmonic distortion and current harmonic distortion effects which pose significant challenges and concerns. Specifically, harmonics generated by nonlinear loads cause harmonic pollution. Consequently, active power filter (APF) is becoming the focal point of the current research and application in the field of reactive power compensation and harmonic filtering. Compared to the traditional passive power filter, APF has the following advantages and features:
1. It has a variety of compensatory functions. For instance, APF can compensate the current harmonic, and can also dynamically compensate reactive power and unbalanced current;
2. Filtering performance is not affected by the impedance of the power grid, and the series-parallel resonance oscillation associated with the impedance of the power grid will not occur;
3. The harmonic compensation performance is not affected by power grid frequency alterations;
4. Dynamic harmonic suppression, which is able to quickly respond to alterations of the harmonic frequency and amplitude, is generated.
5. APF is cost-effective because it can complete multiple harmonic suppression;
6. APF can separately suppress a harmonic load and achieve the harmonic suppression for multiple harmonic loads at the same time.

Because APF has many advantages, it has been increasingly accepted and adopted by the industry. In 1996, F. Z. Peng and J. S. Lai et al. proposed the topology structure of the cascaded multilevel converter in “A Multilevel voltage-source converter with separate DC source for Static Var Generation” (IEEE Transactions on Industry Applications, 1996, 32(5):1130-1138). If the APF uses a cascaded multilevel converter topology, this arrangement has a wide range of application, and can significantly improve the capacity and withstand the voltage level of the APF. The harmonic suppression function generated by the APF has a high switch frequency requirement. In particular, increasing the switch frequency of all the devices will greatly increase the switch loss of the system, thereby increasing the cooling requirements of the system, and decreasing the cost-effectiveness of the system. Additionally, this system creates a DC capacitor voltage imbalance in the cascaded APF, which may pose a safety hazard: switch loss and DC capacitor voltage balancing control creates a bottleneck that restricts the application of the cascaded APF.

Chinese patent ZL200610113547.8 and Chinese patent 201110149521.X provided the DC capacitor voltage balancing method used for the cascaded APF, which sets the special DC capacitor voltage control algorithm for each link. However, the voltage balancing effect is greatly affected by the control parameters, and overshoot and oscillation are produced in the voltage balancing process. Further, Chinese patent 201010257367.3 and Chinese patent 200910238798.2 provided a DC capacitor voltage balancing method for the cascaded APF using an additional circuit. However, this arrangement increases the cost and volume of the system, and greatly increased the complexity of control. Importantly, these patents did not address the fact that each switch device adopts a different switch frequency. To address this concern, Chinese patent 200810226449.4 disclosed a comprehensive voltage quality adjustment device with differentiated configuration, whose main circuit structure uses differentiated switch frequency. In such an arrangement, the high frequency module and low frequency module in the main circuit have to be designed respectively, whose function are not interchangeable with each other.

### SUMMARY OF THE INVENTION

To address the above-discussed deficiencies of the prior art, it is the primary object of the present invention to provide a differentiated control method of the cascaded active power filter, which can significantly reduce the switch loss of the system and ensure DC capacitor voltage balance of each link without affecting harmonic filtering performance in the system.

To solve the above technical problems, the present invention adopts the following technical scheme:

A differentiated control method of the cascaded active power filter, wherein the links of a cascaded multilevel converter have the same topological parameters and are divided into low frequency links and high frequency links based on the switch frequency, wherein the controller computes the voltage requirements to be generated by the cascaded multilevel converter in the control cycle. Also, the low frequency links determine targets of output based on the fundamental voltage requirements of the cascaded multilevel converter. The controller generates the appropriate pulse width modulation (PWM) combination for low frequency links. The high frequency links determine targets of output based on different, separate voltage requirements of the cascaded multilevel converter other than the fundamental voltage requirements referenced above. Additionally, the controller generates the appropriate PWM combination for the high frequency links.

Furthermore, during the control cycle, those links which have not been selected as the high frequency links for a longer time are selected as high frequency links from cascaded links, and the remaining links are selected as low frequency links.

Furthermore, each phase links with the maximum and minimum DC capacitor voltage in the control cycle, as well as those links that the PWM combination discharge and charge most to DC capacitor voltage are determined. The link PWM combination, consisting of the highest DC capacitor voltage, is exchanged with the link that discharges most to the DC capacitor. Also, the link PWM combination, consisting of the lowest DC capacitor voltage, is exchanged with the link that charges most to the DC capacitor. Finally, the adjusted PWM combinations are transferred to each phase cascaded links to drive the corresponding switch devices.

The beneficial effects of the present invention are described as follows:

1) The low frequency links are used to output the fundamental voltage that needs to be output by the cascaded multilevel converter; the high frequency links generate all of the remaining voltage, except for the aforementioned fundamental voltage; the low frequency links and high frequency links together generate the control voltage required to be generated by the cascaded multilevel converter. Therefore, this method will not affect the compensation effect of the system.

2) The high frequency links do not require a custom design. The high frequency links are also selected from the cascaded links according to a designated cycle. Accordingly, the average switch loss of each link is relatively uniform, making it easy for heat dissipation design.

3) The link topology in the low frequency links is completely consistent with that in the high frequency links, which is advantageous for the modular design and production.

4) For the voltage output of the cascaded multilevel converter, the ratio of the fundamental wave voltage is large. Therefore, there are a greater number of low frequency links than high frequency links, which can effectively reduce the switch loss of the system.

5) The DC capacitor voltage balancing algorithm of links is simple and fast. Additionally, there is no overshoot and oscillations in the voltage balancing process, and the pulse of each link is adjusted only on the sequence, so that output characteristics of the cascaded multilevel converter will not be affected.

6) The principle of the present invention can also be suitable for other applications of the cascaded multilevel converter, such as the differentiated control of the static synchronous compensator (STATCOM), static var generator (SVG) and dynamic voltage restorer (DVR) system.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, referenced below:

1: Controller;

2: The cascaded multilevel converter;

3: The reactor;

4: High frequency links;

5: The link.

### DESCRIPTION OF THE PREFERRED EMBODIMENTS

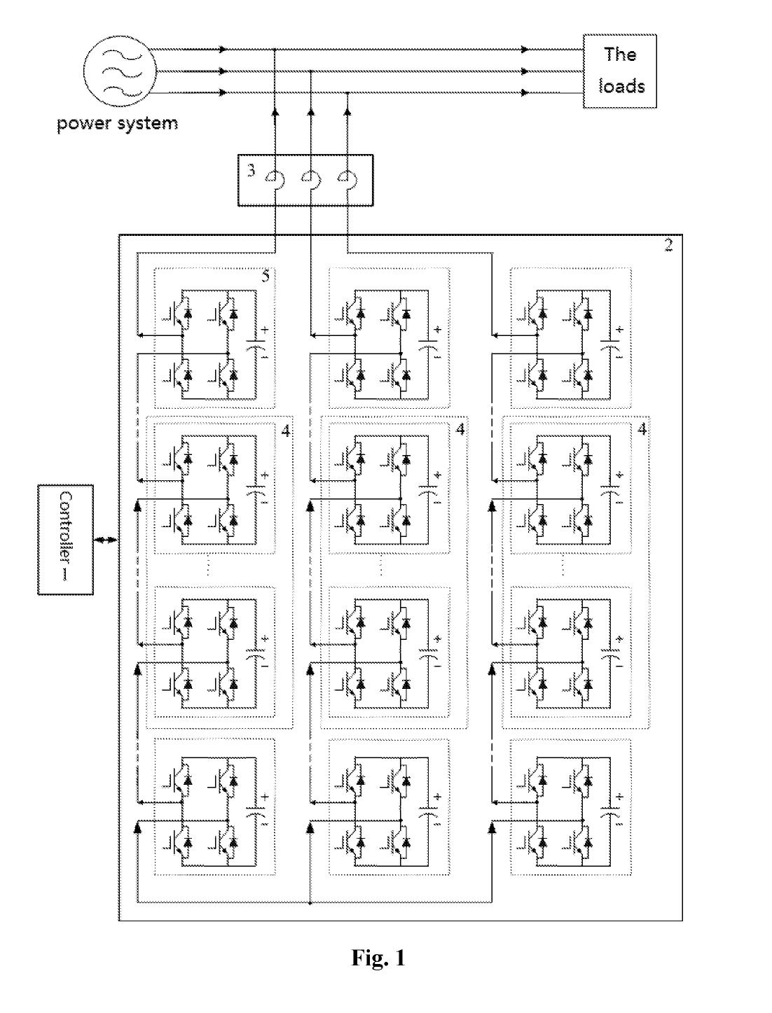

FIG. 1, discussed below, and the various embodiments used to describe the principles of the present invention in this patent document are by way of illustration only and should not be construed in any way to limit the scope of the invention. Those skilled in the art will understand that the principles of the present invention may be implemented in any suitably cascaded active power filter.

As shown in FIG. 1:

FIG. 1 illustrates a differentiated control method structure of the cascaded active power filter comprising a controller 1, the cascaded multilevel converter 2 used to produce voltage compensation, and the reactor 3, which generates compensation current that is connected to the power grid. The present invention operates according to the power grid's requirements of reactive power compensation and harmonic control. Specifically, the controller 1 computes the voltage that needs to be generated by the cascaded multilevel converter 2. The cascaded multilevel converter 2 then produces the compensation voltage. Finally, the cascaded multilevel converter generates the compensation current through the reactor 3. Therefore, the injected current, which is sent to the power grid, compensates the reactive current and harmonic current in power grid. Additionally, the described cascaded multilevel converter 2 can comprise two or more levels of cascaded link 5. In this arrangement, the link uses the H-bridge converter, and all of the links have the same structure. Furthermore, the links of the cascaded multilevel converter 2 are divided into low frequency links and high frequency links according to the switch frequency. For instance, some cascaded links are selected from the cascaded multilevel converter 2 as the high frequency links 4, and the remaining cascaded links are selected as the low frequency links. The low frequency links use the lower switch frequency, and the high frequency links use the higher switch frequency. Preferably, the number of the high frequency links is less than that of the low frequency links.

In each control period, the controller 1 will compute the voltage required to be generated by the cascaded multilevel converter 2. The fundamental voltage that needs to be output by the cascaded multilevel converter 2 is regarded as the output target of the low frequency links, and the controller 1 generates the corresponding PWM combination for the low frequency links. Additionally, except for the aforementioned fundamental voltage generated by the cascaded multilevel converter 2, the voltage is regarded as the output target of the high frequency links 4, and the controller 1 generates the corresponding PWM combination for the high frequency links.

Furthermore, during operation of the present invention, each phase links that have not been selected as the high frequency links for a longer cycle are selected as the high frequency from cascaded links of the cascaded multilevel converter 2 according to the control cycle , and the remaining are selected as the low frequency links.

Further, during the control cycle, each phase links with the maximum and minimum DC capacitor voltage, as well as those links that the PWM combination discharge and charge most to DC capacitor voltage are determined. The link PWM combination, consisting of the highest DC capacitor voltage, is exchanged with the link that discharges most to the DC capacitor. Also, the link PWM combination, consisting of the lowest DC capacitor voltage, is exchanged with the link that charges most to the DC capacitor. Finally, the adjusted PWM combinations are transferred to each phase cascaded links to drive the corresponding switch devices.

As a whole, the control method of the cascaded active power filter described in the present invention uses the differentiated control method. Specifically, the target output voltage of the cascaded multilevel converter is separated into the fundamental voltage and harmonic voltage, which are generated by the low frequency links and the high frequency links respectively. Additionally, the high frequency links are selected circularly from all of the links based on a certain cycle, which can make the average switch loss of each link relatively uniform. This arrangement is useful for determining the heat dissipation design of the links. The ratio of the fundamental voltage in the control voltage that needs to be generated by the cascaded multilevel converter is large. Consequently, the number of the low frequency links is more than that of the high frequency links, which can effectively reduce the switch loss of the system. Furthermore, the DC capacitor voltage balancing method of links executes the voltage balancing control of the links with the maximum and/or minimum amount of DC capacitor voltage. This is a simple and effective theory consisting of fast voltage-balancing without overshoot and oscillations. The PWM combination of each link is adjusted only on the sequence, which will not affect the output performance of the cascaded multilevel converter.

Of course, the principle of the present invention is also suitable for other applications of the cascaded multilevel converter, such as the differentiated control of the static synchronous compensator (STATCOM), static var generator (SVG), and dynamic voltage restorer (DVR) system.

Although the present invention has been described in detail, those skilled in the art should understand that they can make various changes, substitutions and alterations herein without departing from the spirit and scope of the invention in its broadest form.

1. (canceled)

2. (canceled)

3. (canceled)

4. A differentiated control method of the cascaded active power filter, wherein the links of the cascaded multilevel converter are divided into low frequency links and high frequency links based on the switch frequency; wherein the controller compute the voltage requirements to be generated by the cascaded multilevel converter in the control cycle; wherein the low frequency links determine targets of output based on the fundamental voltage requirements of the cascaded multilevel converter; wherein the controller generates the appropriate pulse width modulation (PWM) combination for low frequency links; wherein the controller generates the appropriate PWM combination for the high frequency links; and wherein during the control cycle, those links which have not been selected as the high frequency links for a longer cycle are selected as high frequency links from cascaded links, and wherein the remaining links are selected as low frequency links.

5. The method of claim 4, wherein the high frequency links determine targets of output based on different, separate voltage requirements of the cascaded multilevel converter other than the said fundamental voltage requirements.

6. The method of claim 5, further comprising the steps of:
determining each phase that links with the maximum and minimum DC capacitor voltage in the control cycle, and those links to which the PWM combinations discharge and charge most to DC capacitor voltage;
exchanging the link PWM combination, consisting of the highest DC capacitor voltage, with the link that discharges most to the DC capacitor;
exchanging the link PWM combination, consisting of the lowest DC capacitor voltage, with the link that charges most to the DC capacitor.
transferring the adjusted PWM combinations to each phase cascaded links to drive the corresponding switch devices.
